(19) United States
(12) Patent Application Publication
(10) Pub. No.: US 2024/0345046 A1
(43) Pub. Date: Oct. 17, 2024

(54) WAVEFORM-ANALYZING METHOD, WAVEFORM-ANALYZING DEVICE, AND ANALYZING SYSTEM

(71) Applicant: SHIMADZU CORPORATION, Kyoto (JP)

(72) Inventors: Hitomi YOSHIYAMA-KITAJIMA, Kyoto (JP); Shinji KANAZAWA, Kyoto (JP)

(73) Assignee: SHIMADZU CORPORATION, Kyoto (JP)

(21) Appl. No.: 18/631,581

(22) Filed: Apr. 10, 2024

(30) Foreign Application Priority Data
Apr. 13, 2023 (JP) 2023-065939

(51) Int. Cl. G01N 30/86; G01N 30/72

(52) U.S. Cl. CPC G01N 30/8637; G01N 30/8606; G01N 30/72

(57) ABSTRACT

A model for locating a peak portion in a chromatogram or similar waveform is trained by machine learning using multiple sets of partial waveforms prepared by dividing each reference waveform having a known peak position. An analysis-target waveform is divided into partial waveforms, and whether or not a partial waveform is a peak portion is determined for each partial waveform by the trained model, to estimate different kinds of regions in the analysis-target waveform, including an overlap-peak region. For an overlap peak within a region estimated to be an overlap-peak region, whether or not that peak is a multimodal peak originating from one component is determined, using at least the height of a peak in the overlap peak, the depth of the trough between two neighboring peaks, or the horizontal width of the portion between the bottom of the trough and the top of one of the neighboring peaks.

### TECHNICAL FIELD

The present invention relates to a method and device for analyzing a signal waveform acquired with an analyzing system, as well as an analyzing system including that type of waveform-analyzing device.

### BACKGROUND ART

In a chromatogram acquired with a gas chromatograph (GC), liquid chromatograph (LC) or similar analyzing device, a peak originating from a component in a sample appears. A data-processing device provided for those types of analyzing devices is normally configured to detect peaks by performing a waveform-processing operation on a chromatogram acquired through an analysis, and to identify a peak corresponding to the target compound by performing an identifying operation on each of the detected peaks. The concentration or content of the compound corresponding to an identified peak is calculated from the area or height of that peak.

To date, various methods have been practically used as methods for detecting peaks. In recent years, methods which employ machine learning have been proposed and put into practical use as a new type of peak detection method (see Patent Literature 1 and Non Patent Literature 1).

In a waveform-analyzing method described in Patent Literature 1, each reference waveform with the position of the peak portion already known is divided into segments along the time axis to prepare a set of partial waveforms for each of the reference waveforms, and machine learning is performed using a large number of sets of partial waveforms prepared for the reference waveforms to create a trained model for identifying a partial waveform corresponding to a peak portion in an input waveform. Similar to the reference waveforms, an analysis-target waveform is also divided into a plurality of partial waveforms, and the trained model is applied to each of those partial waveforms to determine whether the partial waveform corresponds to a peak portion. Based on the determination result, the peak regions and other regions in the entire analysis-target waveform are determined. Machine learning can also be performed using a partial waveform corresponding to a peak-beginning or peak-ending point, other than the peak portion, to create a model with which a partial waveform corresponding to a peak-beginning or peak-ending point can be found among a plurality of partial waveforms in an analysis-target waveform.

### CITATION LIST

### Patent Literature

Patent Literature 1: WO 2021/064924 A

### Non Patent Literature

Non Patent Literature 1: “Peakintelligence™, Peak Processing Optional Software for LabSolutions Insight™”, [online], [accessed on Mar. 16, 2023], Shimadzu Corporation, the Internet

Non Patent Literature 2: Olaf Ronneberger and two other authors, “U-Net: Convolutional Networks for Biomedical Image Segmentation”, [online], [submitted on 18 May 2015], arXiv.org, the Internet

### SUMMARY OF INVENTION

### Technical Problem

It is often the case that peaks originating from a plurality of components are observed overlapping each other in a chromatogram or similar type of waveform. Therefore, it is noted that a processing operation for separating overlapping peaks, such as tailing processing, complete separation or vertical partitioning, can also be performed in the waveform-analyzing method described in Patent Literature 1. In the peak detection which employs machine learning, the separation technique which can most appropriately separate overlapping peaks being analyzed can be determined by learning the waveform shape, peak-beginning point, peak-ending point and other features of a variety of overlapping peaks.

In a chromatogram acquired by analyzing a sample having a particularly low level of component concentration by means of a gas chromatograph mass spectrometer (GC-MS) or liquid chromatograph mass spectrometer (LC-MS), the peak may appear in a multimodal shape since the number of ions originating from the target component is small. A peak having a multimodal shape (which is hereinafter called the “multimodal peak”) is apparently difficult to be distinguished from a plurality of overlapping peaks (this type of overlapping peaks is hereinafter called the “overlap peak”). Therefore, in the conventional peak detection method which employs machine learning, a trough portion in a multimodal peak may possibly be misidentified as peak-ending and peak-beginning points, which has been a cause of the false detection of a peak.

The objective of the present invention is to provide a waveform-analyzing method and a waveform-analyzing device by which a multimodal peak can be accurately recognized by reducing the number of cases in which a peak having a multimodal shape due to a particularly low level of component concentration or other reasons is misidentified as an overlap peak in a peak detection process which employs machine learning.

### Solution to Problem

One mode of the waveform-analyzing method according to the present invention is a waveform-analyzing method for analyzing a signal waveform which is a chromatogram or a spectrum, the method including:
a model creation step for creating a trained model for locating a peak portion in an input waveform, by machine learning using a plurality of sets of partial waveforms prepared by dividing each reference waveform in which the position of the peak portion is already known;
a region estimation step which includes dividing an analysis-target waveform into a plurality of partial waveforms, determining whether or not a partial waveform is a peak portion for each of the plurality of partial waveforms by using the trained model, and estimating a plurality of different kinds of regions including a single-peak region, overlap-peak region and non-peak region in the analysis-target waveform based on the result of the determination; and
a multimodality determination step which includes determining, for an overlap peak within a region estimated to be an overlap-peak region in the region estimation step, whether or not the overlap peak is a multimodal peak originating from a single component, using at least one of the following pieces of information: the height of one or more peaks among a plurality of peaks in the overlap peak; the depth of the trough between two neighboring peaks among the plurality of peaks; and the width in the direction of the horizontal axis between the bottom portion of the trough and the top portion of one of the peaks between which the trough is sandwiched.

One mode of the waveform-analyzing device according to the present invention is a waveform-analyzing device configured to analyze a signal waveform which is a chromatogram or a spectrum, the device including:
a region estimator configured to divide an analysis-target waveform into a plurality of partial waveforms, to determine whether or not a partial waveform is a peak portion for each of the plurality of partial waveforms of the analysis-target waveform, by using a trained model created by machine learning using a plurality of sets of partial waveforms prepared by dividing each reference waveform in which the position of the peak portion is already known, and to estimate a plurality of different kinds of regions including a single-peak region, overlap-peak region and non-peak region in the analysis-target waveform based on the result of the determination; and
a multimodality determiner configured to determine, for an overlap peak within a region estimated to be an overlap-peak region by the region estimator, whether or not the overlap peak is a multimodal peak originating from a single component, using at least one of the following pieces of information: the height of one or more peaks among a plurality of peaks in the overlap peak; the depth of the trough between two neighboring peaks among the plurality of peaks; and the width in the direction of the horizontal axis between the bottom portion of the trough and the top portion of one of the peaks between which the trough is sandwiched.

Furthermore, one mode of the analyzing system according to the present invention is an analyzing system which is a chromatograph system, a mass spectrometer or an optical measurement device and includes one mode of the waveform-analyzing device according to the present invention as a data analyzer.

### Advantageous Effects of Invention

In the previously described modes of the waveform-analyzing method and the waveform-analyzing device according to the present invention, when a peak detected by a peak detection process which employs machine learning has been identified as an overlap peak in which two or more peaks originating from different kinds of components overlap each other, whether or not the overlap peak concerned is a multimodal peak originating from a single component is determined by waveform processing performed after the peak detection process. The result of this determination can be presented to the user, or it can be used for correcting the estimation result indicating that the peak is an overlap peak, without requiring manual intervention. Therefore, the accuracy of the automatic peak detection can be improved, including a multimodal peak which is likely to appear, for example, in the case where the concentration of the component is low.

### BRIEF DESCRIPTION OF DRAWINGS

FIG. 1 is a schematic configuration diagram of one embodiment of an analyzing system for carrying out a waveform-analyzing method according to the present invention.

FIG. 2 is a flowchart showing the procedure of a trained model creation process in the analyzing system according to the present embodiment.

FIG. 3 is a flowchart showing the procedure of a peak detection process on a chromatogram waveform to be analyzed in the analyzing system according to the present embodiment.

FIG. 4 is a waveform diagram showing one example of a determination process for a multimodal peak.

FIG. 5 is a waveform diagram showing one example of a determination process for a multimodal peak.

FIG. 6 is a waveform diagram showing one example of a determination process for a multimodal peak.

FIGS. 7A-7C are waveform diagrams for explaining a method for dividing an overlap peak.

FIG. 8 is a diagram for explaining one example of a method for integrating a multimodal peak.

FIG. 9 is a diagram for explaining one example of a method for integrating a multimodal peak.

### DESCRIPTION OF EMBODIMENTS

In the previously described modes of the waveform-analyzing method and the waveform-analyzing device according to the present invention, the signal waveform includes a chromatogram acquired with a GC system including a GC-MS and a chromatogram acquired with an LC system including an LC-MS, as well as an electropherogram acquired with an electrophoresis apparatus. In the case of a GC or LC system using a mass spectrometer as a detector, the chromatogram includes a total ion (total ion current) chromatogram and an extracted ion chromatogram. The spectrum includes a mass spectrum acquired with a mass spectrometer (a profile spectrum without centroid processing), a time-of-flight spectrum acquired with a time-of-flight mass spectrometer and not yet converted into a mass spectrum, an optical intensity spectrum acquired with an optical measurement apparatus, such as a spectrophotometer or fluorometer, as well as an X-ray intensity spectrum acquired with an X-ray analyzer.

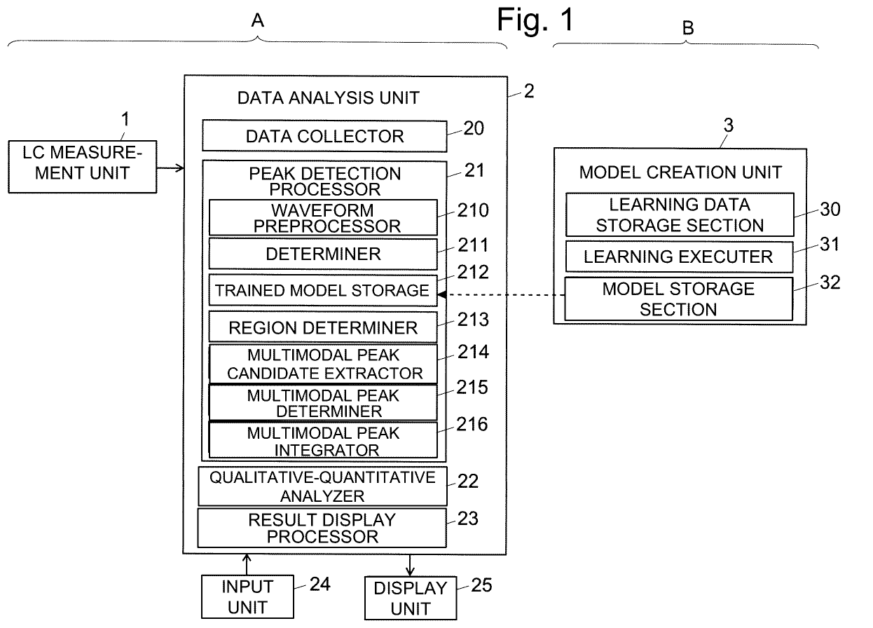

Hereinafter, an LC system is described, with reference to the attached drawings, as one embodiment of an analyzing system including a waveform-analyzing device in which a waveform-analyzing method according to the present invention is carried out. FIG. 1 is a schematic configuration diagram of an LC system A according to the present embodiment as well as a system B which creates a trained model to be used in the LC system A.

The LC system A in the present embodiment includes an LC measurement unit 1, data analysis unit 2, input unit 24 and display unit 25. Though not shown, the LC measurement unit 1 includes a liquid-supply pump, injector, column, column oven, detector and other components, to perform an LC analysis on a given sample and acquire chromatogram data which show a temporal change in the intensity of a signal obtained with the detector. There is no specific limitation on the type of detector and the detection method; for example, a mass spectrometer or photodiode array (PDA) detector can be used.

The data analysis unit 2 includes a data collector 20, peak detection processor 21, qualitative-quantitative analyzer 22, display processor 23 and other functional blocks. The peak detection processor 21 includes a waveform preprocessor 210, determiner 211, trained model storage section 212, region determiner 213, multimodal peak candidate extractor 214, multimodal peak determiner 215, multimodal peak integrator 216 and other functional blocks.

In the data analysis unit 2, the data collector 20 accumulates chromatogram data acquired in the LC measurement unit 1 and stores those data in a memory unit. According to an instruction received from a user through the input unit 24, the peak detection processor 21 automatically detects peaks in a chromatogram waveform constructed from the accumulated chromatogram data and produces peak information of each detected peak including the beginning and ending positions (retention time), range of the peak region and other pieces of information. Based on the peak information given from the peak detection processor 21, the qualitative-quantitative analyzer 22 identifies a component (compound) corresponding to each peak, as well as calculates a peak-height value or peak-area value and computes a quantitative value as the concentration or content of each component from that peak-height or peak-area value. The display processor 23 shows the peak detection result as well as the quantitative value and other related values calculated from the peak detection result, in a predetermined form on the display unit 25.

In common cases, the data analysis unit 2 is actually a personal computer or more sophisticated workstation on which predetermined software (computer program) is installed, or a computer system including a high-performance computer connected to the previously mentioned types of computers via a data communication network. In other words, the function of each block included in the data analysis unit 2 is embodied by a stand-alone computer or on a computer system including a plurality of computers by executing specific software installed on the computer or computers. Needless to say, some of those functions may be implemented by using a hardware circuit dedicated to specific types of mathematical operations, such as a digital signal processor.

The computer program can be offered to users in the form of a non-transitory computer-readable record medium holding the program, such as a CD-ROM, DVD-ROM, memory card, or USB memory (dongle). The program may also be offered to users in the form of data transferred through the Internet or similar communication networks. The program can also be preinstalled on a computer (or more exactly, on a storage device as a component of a computer) as a part of a system before a user purchases the system.

In FIG. 1, the system B, which is provided apart from the LC system A, includes a model creation unit 3. The model creation unit 3 includes a learning data storage section 30, learning executer 31 and model storage section 32 as its functional blocks. The trained model created in this model creation unit 3 is stored in the trained model storage section 212 in the data analysis unit 2 of the LC system A.

As will be detailed later, the task of creating a trained model normally requires a huge amount of calculation. Therefore, the system B is actually a high-performance computer, with the function of each block embodied by executing, on that computer, a piece of software installed on the same computer. Needless to say, the system B may be unified with the LC system A.

Next, the peak detection process to be performed by the peak detection processor 21 and other related sections in the data analysis unit 2 is described.

An extremely simple description of the operations in the peak detection processor 21 is as follows: A chromatogram waveform constructed from chromatogram data is converted into an image. The technique of semantic segmentation based on deep learning, which is a technique of machine learning for determining the category and position of an object present on an image, is applied to the image to detect the position or range of each of the plurality of kinds of regions (which will be described later).

### Creation of Trained Model

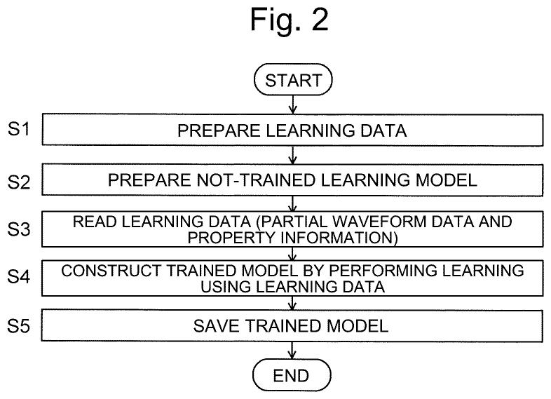

As is commonly known, machine learning methods require previously constructing a trained model using a large amount of learning data (training data and verification data). As noted earlier, the task of creating the trained model is not performed in the data analysis unit 2, which is a portion of the LC system A, but in the model creation unit 3 consisting of another computer system, and the resultant model is stored in the model storage section 212. FIG. 2 is a flowchart schematically showing the procedure of the trained model creation process performed in the model creation unit 3.

For the creation of a trained model, learning data based on reference waveforms are initially prepared (Step S1). A huge number and wide variety of chromatograms waveforms are used as the reference waveforms in this step. The “wide variety of chromatogram waveforms” in the present context should preferably be chromatogram waveforms including the mixture of various types of noise, fluctuation (drift) of the base line, overlap of multiple peaks, deformation of the peak shape and other elements which may possibly occur in a chromatogram waveform in the actual process of peak detection. It should be noted that the chromatogram waveform data do not need to be data collected through actual LC analyses; they may also be data created through simulations.

For each chromatogram waveform used as a reference waveform, a peak detection process is performed beforehand, whereby the accurate beginning and ending points are determined for one or more peaks on the waveform. This chromatogram waveform is converted into an image after the normalization of the signal intensity, i.e., the vertical axis in the graph, and is further divided into a predetermined number of partial waveforms along the horizontal axis, i.e., in the time-axis direction. The number of divisions is determined so that the width (or length in the time-axis direction) of each partial waveform will be smaller than the peak width. Accordingly, the number of divisions can be appropriately set depending on the minimum value of the expected peak width.

One chromatogram waveform consists of many partial waveforms. The data forming each partial waveform is related to property information which indicates the kind of region which the partial waveform corresponds to among specific kinds of regions. In the present embodiment, there are seven kinds of regions: a single-peak region, which corresponds to a peak portion on the chromatogram waveform and includes a single peak, with no other peaks overlapping this peak; a tailing processing peak region, which corresponds to a peak portion on the chromatogram waveform and has a peak, with another peak overlapping in such a manner that the tailing processing is suited as the method for dividing the peak; a complete separation peak region which corresponds to a peak portion on the chromatogram waveform and has a peak, with another peak overlapping in such a manner that the complete separation is suited as the method for dividing the peak; a vertical partitioning peak region which corresponds to a peak portion on the chromatogram waveform and has a peak, with another peak overlapping in such a manner that the vertical partitioning is suited as the method for dividing the peak; a peak-beginning region, which includes the beginning point of the peak; a peak-ending region, which includes the ending point of the peak; and a non-peak region, which is not a peak portion (and normally corresponds to the base line). The tailing processing peak region, complete separation peak region and vertical partitioning peak region are hereinafter collectively called the “overlap-peak region” since they include two or more peaks overlapping each other.

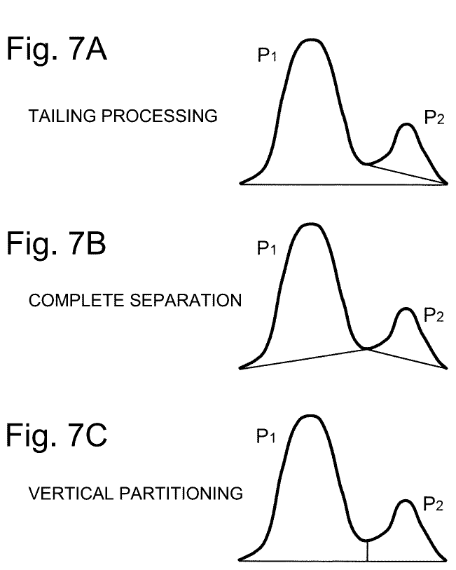

Methods for dividing a peak are hereinafter described with reference to FIGS. 7A-7C.

The tailing processing, as shown in FIG. 7A, is a method in which a peak is divided into two peaks in such a manner that the region from the beginning point to the ending point of the overlap peak as the target is assumed to be one peak, with another peak superposed on that peak. The complete separation, as shown in FIG. 7B, is a method in which two peaks in the overlap peak as the target are separated from each other by connecting the beginning point, local minimum point and ending point of the overlap peak by line segments in series. The vertical partitioning, as shown in FIG. 7C, is a method in which two peaks in the overlap peak as the target are separated from each other by a vertical line passing through the local minimum point in the overlap peak. These methods are used in conventional and common peak detection methods and are not limited to the peak detection methods which employ machine learning.

In the case of tailing processing, the beginning and ending points of the two peaks are sequentially located in ascending order of retention time in such a manner that the beginning point of the first peak and that of the second peak initially appear, followed by the ending point of the first peak and that of the second peak. In the case of the complete separation or vertical partitioning, those points are sequentially located in ascending order of retention time in such a manner that the beginning point and the ending point of the first peak initially appear, followed by the beginning point and the ending point of the second peak. In some cases, a different type of dividing method may be used in which peaks are separated by a fitting using a Gaussian function or similar model function.

For the classification into the seven aforementioned kinds of regions, reference waveforms are prepared, such as reference waveforms each including a single peak as well as reference waveforms each including an overlap peak separated into peaks by one of the three methods of tailing processing, complete separation and vertical partitioning. For each reference waveform, a set of partial waveforms is created by dividing the reference waveform, to prepare a plurality of sets of partial waveforms for each of the aforementioned types of reference waveforms. Each partial waveform is given property information indicating the kind of region which the partial waveform corresponds to. The partial waveform data forming each of the large number of chromatogram waveforms and the corresponding property information are related to each other and stored in the learning data storage section 30. The learning data may be previously divided into training data and verification data, or such a division may be omitted so that each piece of data can be appropriately used as training data or verification data when the learning is performed.

When a command to initiate the creation of the learning model is issued, the learning executer 31 prepares a learning model which has not been trained yet (Step S2). Various models with which semantic segmentation can be performed may be used as this learning model. Semantic segmentation is generally used for analyzing an image consisting of pixel data distributed in a two-dimensional form. In the present case, however, the technique is applied to an analysis of the waveform of a chromatogram consisting of a series of data arrayed in a one-dimensional form along the time axis. In the present embodiment, U-Net (see Non Patent Literature 2) is used as the learning model with which semantic segmentation can be performed, although other learning models may also be used, such as SeGNet or PSPNet.

Next, the learning executer 31 reads learning data (partial waveform data and property information) from the learning data storage section 30 (Step S3). The learning executer 31 performs machine learning using the read learning data and constructs a learning model for estimating the kind of region which a given partial waveform corresponds to (Step S4). No detailed description of the learning procedure will be hereinafter given. For example, a trained model can be constructed according to a procedure described in Patent Literature 1.

In the model storage section 32, the trained model created by the machine learning using a large number of sets of learning data is saved (Step S5). The trained model thus saved in the model storage section 32 is transmitted to and stored in the trained model storage section 212 in the LC system A through a data communication network, for example.

### Peak Detection Process for Analysis—Target Waveform

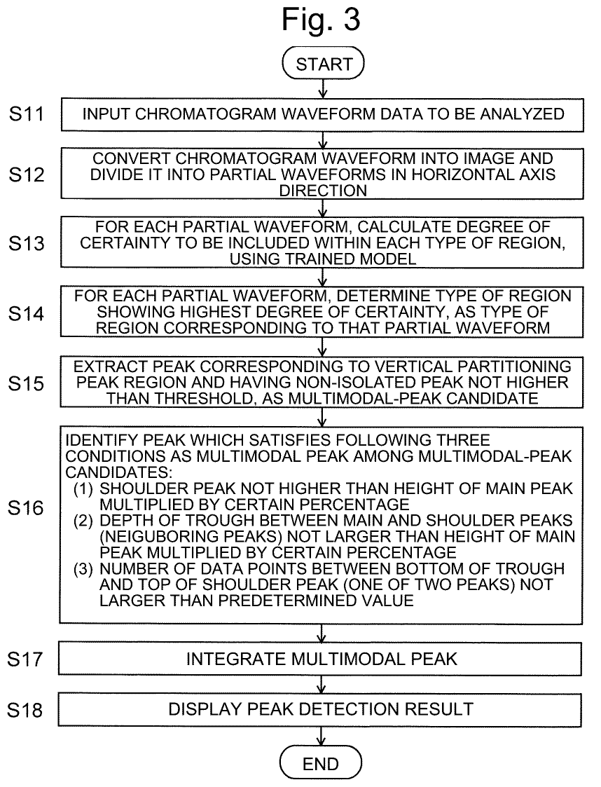

Next, the process of detecting a peak on a chromatogram waveform acquired for a target sample, performed by the data analysis unit 2 in the LC system A, is described. FIG. 3 is a flowchart schematically showing the sequence of the peak detection process performed in the peak detection processor 21.

Initially, the waveform preprocessor 210 reads chromatogram waveform data to be analyzed from the data collector 20 (Step S11). After normalizing the signal intensity of the read data, the waveform preprocessor 210 converts the data into an image and divides the chromatogram waveform in the image into a predetermined number of partial waveforms in the horizontal-axis (time-axis) direction (Step S12). The number of divisions may be equal to the number of divisions in the learning data, although it may also be a different number as long as the width of the partial waveforms is smaller than the peak width.

Subsequently, the determiner 211 reads the trained model from the trained model storage section 212 and sequentially inputs partial waveforms into that model. For each input partial waveform, the trained model determines whether or not the partial waveform corresponds to each of the seven kinds of regions, i.e., the single-peak region, tailing processing peak region, complete separation peak region, vertical partitioning peak region, peak-beginning region, peak-ending region and non-peak region. Specifically, in the present embodiment, the determiner 211 using the trained model calculates certainty information for each partial waveform and each kind of region, where the certainty information is a numerical value representing the probability that the partial waveform concerned corresponds to the kind of region concerned (Step S13). A higher value of the degree of certainty means a higher probability that the partial waveform corresponds to the kind of region concerned. Thus, the determiner 211 outputs all partial waveforms forming the input chromatogram waveform, with each partial waveform having certainty information in each of the seven kinds of regions, such as the single-peak region and the peak-beginning region.

The region determiner 213 receives the output from the determiner 211 and determines, for each partial waveform, the kind of region corresponding to that partial waveform, assuming that a region which shows the highest degree of certainty should be the region corresponding to that partial waveform (Step S14). Thus, each of the partial waveforms forming the entire chromatogram waveform is classified into one of the previously mentioned kinds of regions.

In usual cases, the peaks on a chromatogram can be detected with a considerable level of accuracy by the determination using the trained model. However, since a multimodal peak consisting of a plurality of peaks originating from a single component (compound) has a similar appearance to an overlap peak, there may be the case where a multimodal peak is misidentified as an overlap peak. In the system according to the present embodiment, in order to improve the peak detection accuracy, a post-processing function that follows the previously described determination process employing machine learning is provided which includes determining whether or not a plurality of peaks is a multimodal peak and integrating those peaks into a single peak if they are a multimodal peak.

For example, multimodal peaks are likely to occur in the case where a mass spectrometer is used as the detector and the concentration of the component in the sample is low. This is because a low concentration of the component means that the number of ions produced in the ion source in the mass spectrometer is originally small, so that a fluctuation in the ion production efficiency, ion passage efficiency or ion detection efficiency (or the like) in the device is likely to produce a noticeable effect on the fluctuation in the detection signal. Furthermore, the peak waveform is likely to have a shape in which a peak which should originally be a single peak is partially missing (or indented). This type of peak portion is unlikely to be misidentified as a tailing processing peak region or complete separation peak region in Steps S13 and S14; in most cases, it tends to be misidentified as a vertical partitioning peak region.

Accordingly, upon receiving the result of the determination of the region by the region determiner 213, the multimodal peak candidate extractor 214 initially extracts a peak portion identified as a vertical partitioning peak region (this portion normally includes a plurality of continuous partial waveforms). Subsequently, in each of the extracted peak portions, the multimodal peak candidate extractor 214 determines whether or not the height (i.e., the height of the peak top from the baseline in the vertical partitioning) of a shoulder peak (a peak located on the skirt of a larger peak having a higher peak value) is equal to or smaller than a predetermined threshold, and extracts a peak portion including a shoulder peak equal to or lower than that threshold as a multimodal peak candidate (Step S15). The latter condition is aimed at extracting a peak corresponding to a component whose concentration is low to a certain extent.

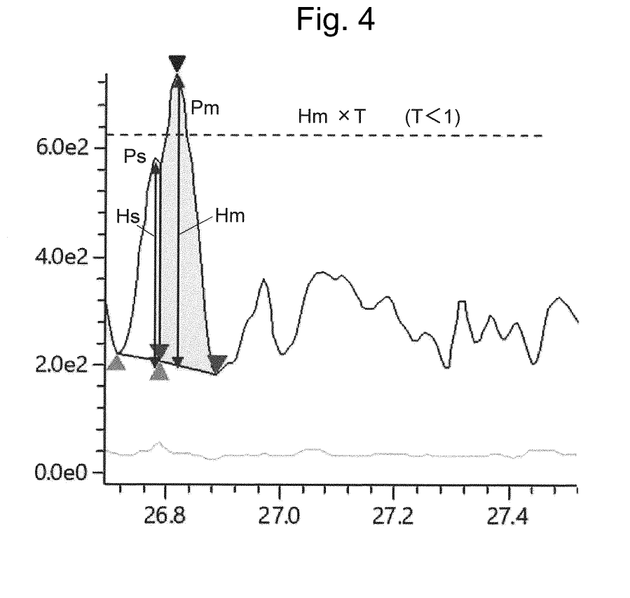

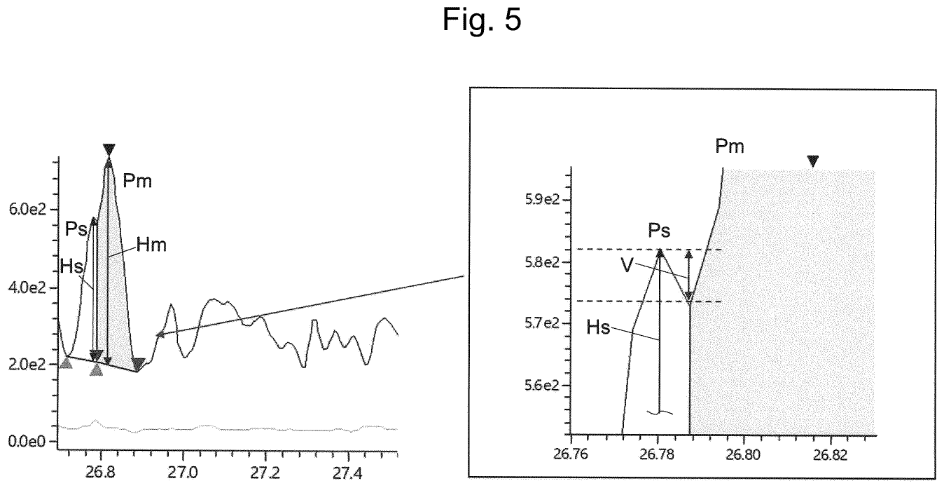

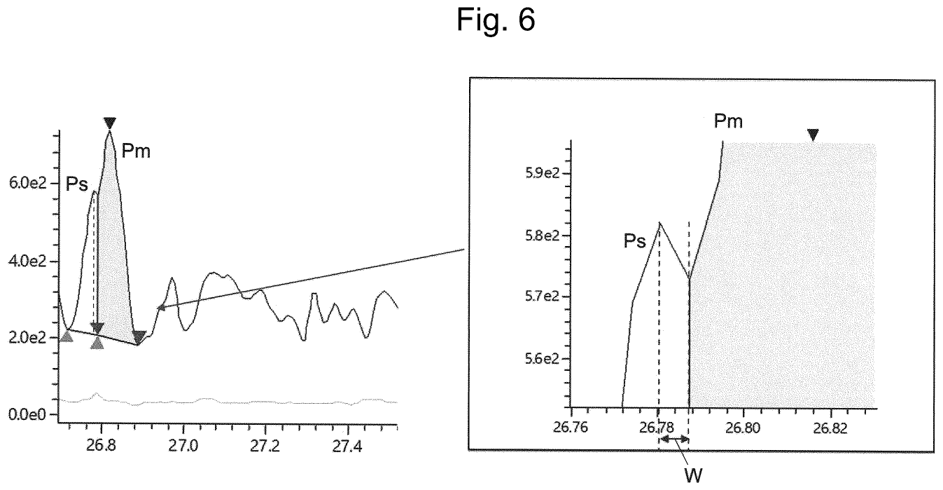

Next, for each multimodal peak candidate, the multimodal peak determiner 215 determines whether or not the peak satisfies all of the following three conditions and identifies a peak which satisfies the three conditions as a multimodal peak (Step S16).
<Condition 1> The height Hs of a shoulder peak Ps in one multimodal peak should not be larger than the height Hm of the highest main peak Pm multiplied by a specific percentage T (see FIG. 4). The percentage T can be appropriately determined. For example, it may be set within a range from 60% to 95%, and more specifically, it may be 90%.
<Condition 2> The depth of the trough between two peaks neighboring each other in the time direction, or on the horizontal axis, should not be larger than the height of one of the two peaks multiplied by a specific percentage. As shown in FIG. 5, what is determined in this case is whether or not the depth V (the difference in height between the bottom portion of the trough and the peak top of the shoulder peak Ps) of the trough between the main peak Pm and the shoulder peak Ps is not larger than the height Hs of the shoulder peak Ps multiplied by a specific percentage M. This percentage M can also be appropriately determined. For example, it may be set within a range from 5% to 30%, and more specifically, it may be 10%.
<Condition 3> The number of data points obtained during the period of time W between the bottom portion of the trough and the one of the two peaks in Condition 2 (in the present example, the shoulder peak Ps) is not larger than a predetermined threshold N (see FIG. 6). This threshold N can also be appropriately determined. For example, it may be set within a range from 3 to 10, and more specifically, it may be 5.

As described earlier, when the detector is a mass spectrometer, multimodal peaks often occur due to a temporary decrease in the number of detected ions due to a fluctuation in the ion production efficiency, ion passage efficiency or other factors in the mass spectrometer. Therefore, it is rare for the plurality of peaks in a multimodal peak to be approximately equal in height. Therefore, a multimodal peak in which the height difference between the plurality of peaks is equal to or larger than a certain amount can be extracted by imposing Condition 1. Furthermore, in most cases, multimodal peaks have only a small drop of the signal intensity between the plurality of peaks. Therefore, a multimodal peak in which the drop of the signal intensity between the plurality of peaks is small can be extracted by imposing Condition 2. Additionally, in normal cases, the drop of the signal intensity due to the aforementioned cause suddenly occurs, and its recovery is also rapid. Therefore, a multimodal peak in which both the drop and recovery of the signal intensity between the plurality of peaks suddenly occur can be extracted by imposing Condition 3.

It is possible to apply only one or two of those three conditions, although it is preferable to apply all three conditions. Any method other than those adopted in the present embodiment may also be used as long as the method can locate the previously described features, using at least the peak height, the depth of the trough between the plurality of peaks, or the period of time between the bottom portion of the trough and the top of the peak.

The values of T, M and N used as the determination criteria in Conditions 1-3 may be allowed to be changed by the user through the input unit 24.

Subsequently, for each peak identified as a multimodal peak, the multimodal peak integrator 216 performs a process for integrating the plurality of peaks into one peak (Step S17). There are various methods available for integrating the plurality of peaks.

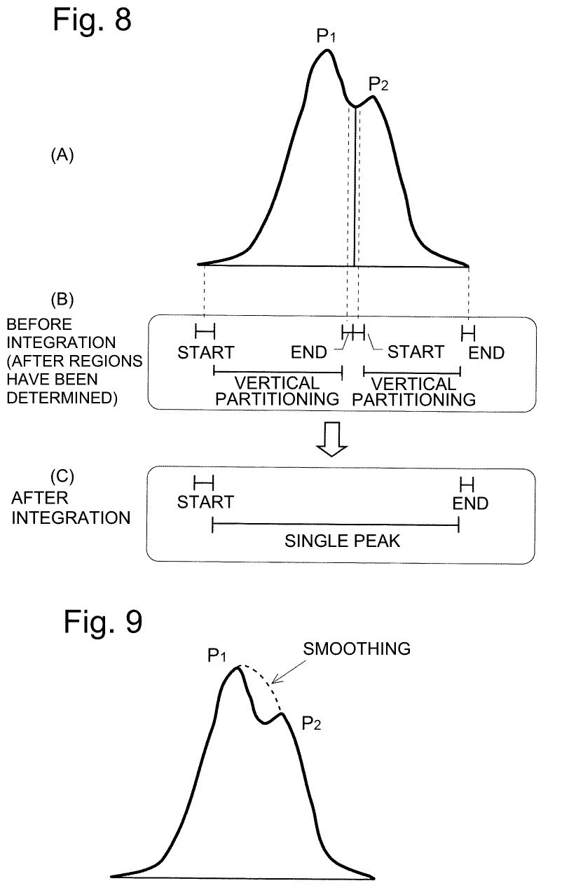

FIG. 8 shows an example of the integration process. If the peak shown in section (A) in FIG. 8 has been identified as a vertical-partitioning peak in Step S14, the regions are normally determined in such a manner that the peak-beginning region, vertical partitioning peak region, peak-ending region, peak-beginning region, vertical partitioning peak region and peak-ending region are sequentially located in order of retention time, as shown in section (B) in FIG. 8. Suppose that this peak has been identified as a multimodal peak in Step S16. Then, the multimodal peak integrator 216 deletes the peak-beginning and peak-ending regions sandwiched between the two vertical partitioning peak regions and replaces the entire portion between the first peak-beginning region and the second peak-ending region with a single-peak region (see section (C) in FIG. 8). Consequently, although the peak shape appears to be an overlap peak, this peak is treated as a single peak, so that a user watching this peak can recognize that it is a multimodal peak originating from a single component.

Needless to say, the peak integration process does not always need to be limited to the alteration of the kind of region; for example, it may also include refining the peak shape by an appropriate waveform processing, such as smoothing, as shown in FIG. 9.

After the process of integrating multimodal peaks has been thus performed as needed, the display processor 23 shows the result of the peak detection by the peak detection processor 21 on the screen of the display unit 25 (Step S18). When the system is set to automatically perform a qualitative analysis based on the peak detection result, the qualitative-quantitative analyzer 22 calculates the retention time of the peak top, for example, for each detected peak and identifies the component corresponding to that peak based on its retention time. When the system is set to automatically perform a quantitative analysis based on the peak detection result, the qualitative-quantitative analyzer 22 determines the peak-area value or peak-height value for each detected peak and calculates the concentration (content) of the component corresponding to that peak by referring to a previously prepared calibration curve for the peak-area value or peak-height value. The display processor 23 shows the result of the qualitative or quantitative analysis along with the peak detection result on the screen of the display unit 25.

As described thus far, in the LC system according to the present embodiment, when a multimodal peak included in the peaks automatically detected by machine learning was incorrectly identified as an overlap peak, the incorrect result can be detected, and the peak information or other related pieces of information can be correctly modified as needed before being presented to the user.

In the previous description, the integration process for a peak identified as multimodal was automatically performed. In some cases, it may be desirable to allow the user to determine whether or not the peak is truly multimodal before the integration process or other types of processes are performed as needed. Accordingly, the system may be configured to initially display the peak waveform identified as a multimodal peak by the multimodal peak determiner 215 on the display unit 25, so as to notify the user of the result, rather than automatically performing the integration process. According to an instruction from the user who has checked the result, the system may perform the peak integration process or delete the identification result indicating the multimodality of the peak so as to treat that peak as an overlap peak.

Next, some additional and preferable configurations will be described. Each of the configurations hereinafter described can be appropriately combined with those described in the previous embodiment. Two or more of those additional configurations may also be combined with each other as long as they do not perform incompatible processes.

For example, in the previous embodiment, for each peak having a plurality of peak portions and identified as a vertical-partitioning peak which is one type of overlap peak, whether or not the peak is a multimodal peak is determined based on specific pieces of information reflecting the waveform shape, such as the peak height, depth of the trough between the peaks, or width of the portion between the bottom portion of the trough and the top portion of the peak. It is possible to further refer to other pieces of information for determining whether or not the peak is a multimodal peak.

Specifically, a piece of numerical information reflecting the shape or property of the peak, such as the signal-to-noise ratio, degree of separation, symmetry factor, area or peak width within the vertical partitioning peak region, may be calculated, and the requirement that this numerical information should be greater or less than a predetermined threshold may be considered as one condition for determining that the peak is a multimodal peak.

For example, as explained earlier, multimodal peaks are likely to occur in the case where the component concentration is low. In such a case, even a peak often has a comparatively low signal-to-noise ratio. Accordingly, it is possible to determine whether or not a signal-to-noise ratio calculated from a signal intensity within the vertical partitioning peak region and a signal intensity within the non-peak region exceeds a predetermined threshold, and to determine that the peak is not multimodal when the threshold is exceeded.

The symmetry factor is an index of the degree of bilateral symmetry of a peak. For example, a peak having a symmetry factor greater than one is a tailing peak. When a peak with a high value of symmetry factor has been detected for a compound which is previously known to form a peak with a considerably low degree of bilateral symmetry, it is possible to assume that a non-isolated peak which has occurred in the tailing portion of that peak is most likely to be a peak originating from a single component rather than other components. Accordingly, the symmetry factor can be used as a determination criterion for concluding that this type of peak should be considered as a multimodal peak and be integrated.

Mass spectrometers normally allow for the observation of a plurality of kinds of ions which are produced from one component and have different m/z values (those ions are called a “target ion” and a “qualifier ion”). Accordingly, a GC-MS or LC-MS can create an extracted ion chromatogram for a target ion as well as one or more extracted ion chromatograms for one or more qualifier ions for the same component. Those chromatograms should be similar in the shape of the waveform since they originate from the same component. Accordingly, it is possible to compare the region estimation result in the chromatogram of the target ion and the region estimation result in the chromatogram of a quantifier ion for the same component, and to make use of the comparison result for the determination on the multimodal peak.

For example, when a peak has been identified as a multimodal peak in either a peak determination result for the target ion or a peak determination result for a qualifier ion of the same component, but not in both results, the result in which the peak has been identified as a multimodal peak may be corrected.

Compound information related to a target compound in a sample, which can be previously known, may additionally be used as a condition for the determination on the multimodal peak. The “compound information” in the present context may include, for example, the concentration of the compound, as well as structural information (e.g., whether or not the compound has an isomer) or information concerning whether or not there is a derivative produced in a pretreatment or other related processes.

In a mass spectrometer, some compounds are easily ionized, while others are difficult to be ionized, due to their difference in nature. Accordingly, even with the same concentration, some kinds of compounds may easily form a peak with a multimodal shape, while others may not. Therefore, an operation which depends on the kind of compound may be added, such as the operation of changing the determination criteria for the multimodal peak.

When the presence of isomers is previously known as compound information, the peaks of those isomers are often temporally separated from each other in the chromatogram due to their structural difference (or the like) even though their molecular weights are equal. Accordingly, it is possible to determine that a plurality of peaks which are presumed to correspond to the target compound are unlikely to be a multimodal peak.

When a smoothing process based on a predetermined algorithm is performed, a clear difference may occur between the multimodal peak and the true vertical-partitioning peak (and other overlap peaks) in terms of the magnitude of the change in waveform shape before and after the smoothing process as well as their form of emergence. Accordingly, this difference in terms of the magnitude of the change or form of emergence may be used for the determination on the multimodal peak.

The previously described waveform-analyzing process for a multimodal peak can be performed not only on a chromatogram acquired through a measurement of an unknown sample but may also be similarly performed on a chromatogram acquired through a measurement of an authentic preparation sample having a known concentration or a blank sample with no target component contained.

Thus, the LC system according to the present embodiment can improve the determination accuracy for multimodal peaks by combining various kinds of information which naturally include those reflecting the waveform shape of an acquired peak as well as other various kinds of additional information. Therefore, more reliable peak information can be provided to the user.

The previous embodiment and variations are mere examples and can be appropriately changed or modified without departing from the spirit of the present invention. Although the waveform-analyzing device for performing peak detection in the previous embodiment is included in the LC system A in which the measurement unit is also included, it may alternatively be configured as a waveform-analyzing device independent of the LC system A. In that case, the device can be configured to read and analyze chromatogram data previously acquired with the LC measurement unit 1.

Although the previously described embodiment was concerned with the case of processing a chromatogram waveform, it is evident that the present invention is applicable to the waveform analysis of a signal waveform acquired with various types of analyzing devices whose signal intensity can alter with a change in the value of a predetermined parameter, such as an electropherogram acquired with an electrophoresis apparatus, a mass spectrum (profile spectrum) acquired with a mass spectrometer, an optical spectrum acquired with an spectrophotometer, a fluorescence spectrum acquired with a fluorometer, or an X-ray intensity spectrum acquired with an X-ray analyzer.

### Various Modes

A person skilled in the art can understand that the previously described illustrative embodiment is a specific example of the following modes of the present invention.

(Clause 1) One mode of the waveform-analyzing method according to the present invention is a waveform-analyzing method for analyzing a signal waveform which is a chromatogram or a spectrum, the method including:
a model creation step for creating a trained model for locating a peak portion in an input waveform, by machine learning using a plurality of sets of partial waveforms prepared by dividing each reference waveform in which the position of the peak portion is already known;
a region estimation step which includes dividing an analysis-target waveform into a plurality of partial waveforms, determining whether or not a partial waveform is a peak portion for each of the plurality of partial waveforms by using the trained model, and estimating a plurality of different kinds of regions including a single-peak region, overlap-peak region and non-peak region in the analysis-target waveform based on the result of the determination; and
a multimodality determination step which includes determining, for an overlap peak within a region estimated to be an overlap-peak region in the region estimation step, whether or not the overlap peak is a multimodal peak originating from a single component, using at least one of the following pieces of information: the height of one or more peaks among a plurality of peaks in the overlap peak; the depth of the trough between two neighboring peaks among the plurality of peaks; and the width in the direction of the horizontal axis between the bottom portion of the trough and the top portion of one of the peaks between which the trough is sandwiched.

(Clause 11) One mode of the waveform-analyzing device according to the present invention is a waveform-analyzing device configured to analyze a signal waveform which is a chromatogram or a spectrum, the device including:
a region estimator configured to divide an analysis-target waveform into a plurality of partial waveforms, to determine whether or not a partial waveform is a peak portion for each of the plurality of partial waveforms of the analysis-target waveform, by using a trained model created by machine learning using a plurality of sets of partial waveforms prepared by dividing each reference waveform in which the position of the peak portion is already known, and to estimate a plurality of different kinds of regions including a single-peak region, overlap-peak region and non-peak region in the analysis-target waveform based on the result of the determination; and
a multimodality determiner configured to determine, for an overlap peak within a region estimated to be an overlap-peak region by the region estimator, whether or not the overlap peak is a multimodal peak originating from a single component, using at least one of the following pieces of information: the height of one or more peaks among a plurality of peaks in the overlap peak; the depth of the trough between two neighboring peaks among the plurality of peaks; and the width in the direction of the horizontal axis between the bottom portion of the trough and the top portion of one of the peaks between which the trough is sandwiched.

In the waveform-analyzing method according to Clause 1 and the waveform-analyzing device according to Clause 11, when a peak detected by a peak detection process which employs machine learning has been identified as an overlap peak in which two or more peaks originating from different kinds of components overlap each other, whether or not the overlap peak concerned is a multimodal peak originating from a single component is determined by waveform processing performed after the peak detection process. The result of this determination can be presented to the user, or it can be used for correcting the estimation result indicating that the peak is an overlap peak, without requiring manual intervention. Therefore, the accuracy of the automatic peak detection can be improved, including a multimodal peak which is likely to appear, for example, in the case where the concentration of the component is low.

(Clause 2) The waveform-analyzing method according to Clause 1 may further include an integration step for integrating a peak identified as a multimodal peak in the multimodality determination step so as to allow the multimodal peak to be treated as a single peak.

(Clause 12) The waveform-analyzing device according to Clause 11 may further include an integrator configured to integrate a peak identified as a multimodal peak by the multimodality determiner so as to allow the multimodal peak to be treated as a single peak.

In the waveform-analyzing method according to Clause 2 and the waveform-analyzing device according to Clause 12, when a peak has been incorrectly identified as an overlap peak by the peak detection which employs machine learning, that peak can be correctly treated as a single peak when the peak information is provided to the user.

(Clause 3) In the waveform-analyzing method according to Clause 2, whether or not the integration by the integration step should actually be performed may be selected according to a user's selection.

(Clause 13) The waveform-analyzing device according to Clause 12 may further include an operation section configured to receive a selecting operation by a user for selecting whether or not the integration by the integrator should actually be performed.

The waveform-analyzing method according to Clause 3 and the waveform-analyzing device according to Clause 13 allow the user to decide whether or not the estimation result obtained with the trained model for a peak identified as a multimodal peak should be corrected. Therefore, for example, when a peak has been identified as a multimodal peak, the user can visually check its waveform shape and judge whether or not the determination result indicating that the peak is multimodal is correct, taking into account other various pieces of information. Based on the judgment, the user can decide that the multimodal peak should be integrated or be left as it is without integration.

(Clause 4) In the waveform-analyzing method according to one of Clauses 1-3, the overlap-peak region may be subdivided into a plurality of kinds of regions according to the method for dividing the overlap peak, including a vertical partitioning peak region, and the multimodality determination step may include making a determination on a peak corresponding to a vertical partitioning peak region as to whether or not the peak is a multimodal peak.

(Clause 14) In the waveform-analyzing device according to one of Clauses 11-13, the overlap-peak region may be subdivided into a plurality of kinds of regions according to the method for dividing the overlap peak, including a vertical partitioning peak region, and the multimodality determiner may be configured to make a determination on a peak corresponding to a vertical partitioning peak region as to whether or not the peak is a multimodal peak.

The method for dividing an overlap peak in the present context includes not only the vertical partitioning but also other methods, such as the tailing processing and the complete separation. In a multimodal peak which occurs due to the separation of multiple peaks originating from one component, a shoulder peak having a comparatively high signal intensity is often observed near the main peak having the highest signal intensity. This type of peak is likely to be incorrectly identified as a vertical-partitioning peak. In the waveform-analyzing method according to Clause 4 and the waveform-analyzing device according to Clause 14, an overlap peak which is unlikely to be a multimodal peak can be excluded before the determination on whether or not overlap peak is a multimodal peak is made, so that the correctness of the determination on the multimodal peak can be improved.

(Clause 5) In the waveform-analyzing method according to one of Clauses 1-4, one of the conditions applied in the multimodality determination step for determining that a peak concerned is a multimodal peak is that the height of the main peak or a shoulder peak is not greater than a predetermined threshold.

(Clause 15) In the waveform-analyzing device according to one of Clauses 11-14, the multimodality determiner may be configured so that one of the conditions applied for determining that a peak concerned is a multimodal peak is that the height of the main peak or a shoulder peak is not greater than a predetermined threshold.

Multimodal peaks are likely to occur in the case where the concentration of the component in the sample is comparatively low, i.e., in the case where the height of the peak in the chromatogram is low. In the waveform-analyzing method according to Clause 5 and the waveform-analyzing device according to Clause 15, the determination on the multimodal peak is performed after the target is narrowed down to components whose concentrations are comparatively low, so that the correctness of the determination on the multimodal peak can be even further improved.

(Clause 6) In the waveform-analyzing method according to one of Clauses 1-5, the multimodality determination step may include making a determination on the multimodal peak by using at least one of the following values: the ratio between the height of the main peak and the height of a shoulder peak; the ratio between the depth of the trough between two peaks neighboring each other and the height of one of the two peaks; and the width of the portion between the bottom portion of the trough and the top portion of one of the two peaks.

(Clause 16) In the waveform-analyzing device according to one of Clauses 11-15, the multimodality determiner may be configured to make a determination on the multimodal peak by using at least one of the following values: the ratio between the height of the main peak and the height of a shoulder peak; the ratio between the depth of the trough between two peaks neighboring each other and the height of one of the two peaks; and the width of the portion between the bottom portion of the trough and the top portion of one of the two peaks.

By the waveform-analyzing method according to Clause 6 and the waveform-analyzing device according to Clause 16, multimodal peaks can be more accurately recognized.

(Clause 7) In the waveform-analyzing method according to one of Clauses 1-6, the multimodality determination step may include calculating one or more of the following values in the overlap-peak region: a signal-to-noise ratio, a degree of separation, a symmetry factor, an area and a peak width, and using the calculated result for the determination on the multimodal peak as well.

(Clause 17) In the waveform-analyzing device according to one of Clauses 11-16, the multimodality determiner may be configured to calculate one or more of the following values in the overlap-peak region: a signal-to-noise ratio, a degree of separation, a symmetry factor, an area and a peak width, and to use the calculated result for the determination on the multimodal peak as well.

In the waveform-analyzing method according to Clause 7 and the waveform-analyzing device according to Clause 17, one or more kinds of information reflecting some features of the shape of the waveform other than the height of the peak or depth of the trough can be used to improve the accuracy of the determination on the multimodal peak.

(Clause 8) In the waveform-analyzing method according to one of Clauses 1-7, the signal waveform may be a chromatogram acquired by chromatograph mass spectrometry, and the multimodality determination step may use both a determination result for a chromatogram of a target ion and a determination result for a chromatogram of a qualifier ion for the same component to make a determination on the multimodal peak.

(Clause 18) In the waveform-analyzing device according to one of Clauses 11-17, the signal waveform may be a chromatogram acquired by chromatograph mass spectrometry, and the multimodality determiner may be configured to use both a determination result for a chromatogram of a target ion and a determination result for a chromatogram of a qualifier ion for the same component to make a determination on the multimodal peak.

A target ion and a qualifier ion originating from the same component should appear as peaks having approximately similar shapes on the extracted ion chromatograms. Accordingly, in the waveform-analyzing method according to Clause 8 and the waveform-analyzing device according to Clause 18, for example, when a peak cannot be appropriately detected for some reasons in one of the two chromatograms, the peak detection result in the other chromatogram can be used to obtain highly accurate peak information.

(Clause 9) In the waveform-analyzing method according to one of Clauses 1-8, the multimodality determination step may use compound information related to a target compound for the determination on the multimodal peak.

(Clause 19) In the waveform-analyzing device according to one of Clauses 11-18, the multimodality determiner may be configured to use compound information related to a target compound for the determination on the multimodal peak.

The “compound information” in the present context may include information concerning the compound itself contained in the sample, such as its concentration value, as well as other kinds of information, such as information concerning an isomer of the compound or information concerning a derivative resulting from a pretreatment or the like.

As noted earlier, a peak originating from a component is likely to have a multimodal shape when the concentration of the component in the sample is low. Accordingly, for example, when the concentration value is previously known as compound information, it is possible to improve the accuracy of the determination on the multimodality while avoiding an unnecessary determination on the multimodal peak, by performing the determination on the multimodal peak only when the concentration value is lower than a predetermined threshold.

(Clause 10) In the waveform-analyzing method according to one of Clauses 1-9, the multimodality determination step may use a change in waveform before and after a smoothing process on an overlap-peak waveform when making a determination on the multimodal peak.

(Clause 20) In the waveform-analyzing device according to one of Clauses 11-19, the multimodality determiner may be configured to use a change in waveform before and after a smoothing process on an overlap-peak waveform when making a determination on the multimodal peak.

By the waveform-analyzing method according to Clause 10 and the waveform-analyzing device according to Clause 20, a peak having such a small multimodal shape that a change in shape occurs by a smoothing process can be identified, so that a multimodal peak can be more accurately identified.

(Clause 21) One mode of the analyzing system according to the present invention is a chromatograph system, a mass spectrometer or an optical measurement device and includes the waveform-analyzing device according to one of Clauses 11-20 as a data analyzer.

The analyzing system according to Clause 21 can achieve a high level of performance in qualitative and quantitative determination by using highly accurate peak information.

### REFERENCE SIGNS LIST

1 . . . LC Measurement Unit
2 . . . Data Analysis Unit
20 . . . Data Collector
21 . . . Peak Detection Processor
210 . . . Waveform Preprocessor
211 . . . Determiner
212 . . . Trained Model Storage Section
213 . . . Region Determiner
214 . . . Multimodal Peak Candidate Extractor
215 . . . Multimodal Peak Determiner
216 . . . Multimodal Peak Integrator
22 . . . Qualitative-Quantitative Analyzer
23 . . . Display Processor
24 . . . Input Unit
25 . . . Display Unit
3 . . . Model Creator
30 . . . Learning Data Storage Section
31 . . . Learning Executer
32 . . . Model Storage Section

1. A waveform-analyzing method for analyzing a signal waveform which is a chromatogram or a spectrum, the method comprising:
a model creation step for creating a trained model for locating a peak portion in an input waveform, by machine learning using a plurality of sets of partial waveforms prepared by dividing each reference waveform in which a position of the peak portion is already known;
a region estimation step which includes dividing an analysis-target waveform into a plurality of partial waveforms, determining whether or not a partial waveform is a peak portion for each of the plurality of partial waveforms by using the trained model, and estimating a plurality of different kinds of regions including a single-peak region, overlap-peak region and non-peak region in the analysis-target waveform based on a result of the determination; and
a multimodality determination step which includes determining, for an overlap peak within a region estimated to be an overlap-peak region in the region estimation step, whether or not the overlap peak is a multimodal peak originating from a single component, using at least one of following pieces of information: a height of one or more peaks among a plurality of peaks in the overlap peak; a depth of a trough between two neighboring peaks among the plurality of peaks; and a width in a direction of a horizontal axis between a bottom portion of the trough and a top portion of one of the peaks between which the trough is sandwiched.

2. The waveform-analyzing method according to claim 1, further comprising an integration step for integrating a peak identified as a multimodal peak in the multimodality determination step so as to allow the multimodal peak to be treated as a single peak.

3. The waveform-analyzing method according to claim 2, wherein whether or not the integration by the integration step should actually be performed is selected according to a user's selection.

4. The waveform-analyzing method according to claim 1, wherein the overlap-peak region is subdivided into a plurality of kinds of regions according to a method for dividing the overlap peak, including a vertical partitioning peak region, and the multimodality determination step includes making a determination on a peak corresponding to a vertical partitioning peak region as to whether or not the peak is a multimodal peak.

5. The waveform-analyzing method according to claim 1, wherein one of conditions applied in the multimodality determination step for determining that a peak concerned is a multimodal peak is that a height of a main peak or a shoulder peak is not greater than a predetermined threshold.

6. The waveform-analyzing method according to claim 1, wherein the multimodality determination step includes making a determination on the multimodal peak by using at least one of following values: a ratio between a height of a main peak and a height of a shoulder peak; a ratio between a depth of a trough between two peaks neighboring each other and a height of one of the two peaks; and a width of a portion between a bottom portion of the trough and a top portion of one of the two peaks.

7. The waveform-analyzing method according to claim 1, wherein the multimodality determination step includes calculating one or more of following values in the overlap-peak region: a signal-to-noise ratio, a degree of separation, a symmetry factor, an area and a peak width, and using the calculated result for the determination on the multimodal peak as well.

8. The waveform-analyzing method according to claim 1, wherein the signal waveform is a chromatogram acquired by chromatograph mass spectrometry, and the multimodality determination step uses both a determination result for a chromatogram of a target ion and a determination result for a chromatogram of a qualifier ion for a same component to make a determination on the multimodal peak.

9. The waveform-analyzing method according to claim 1, wherein the multimodality determination step uses compound information related to a target compound for a determination on the multimodal peak.

10. The waveform-analyzing method according to claim 1, wherein the multimodality determination step uses a change in waveform before and after a smoothing process on an overlap-peak waveform when making a determination on the multimodal peak.

11. A waveform-analyzing device configured to analyze a signal waveform which is a chromatogram or a spectrum, the device comprising:
a region estimator configured to divide an analysis-target waveform into a plurality of partial waveforms, to determine whether or not a partial waveform is a peak portion for each of the plurality of partial waveforms of the analysis-target waveform, by using a trained model created by machine learning using a plurality of sets of partial waveforms prepared by dividing each reference waveform in which a position of the peak portion is already known, and to estimate a plurality of different kinds of regions including a single-peak region, overlap-peak region and non-peak region in the analysis-target waveform based on a result of the determination; and
a multimodality determiner configured to determine, for an overlap peak within a region estimated to be an overlap-peak region by the region estimator, whether or not the overlap peak is a multimodal peak originating from a single component, using at least one of following pieces of information: a height of one or more peaks among a plurality of peaks in the overlap peak; a depth of a trough between two neighboring peaks among the plurality of peaks; and a width in a direction of a horizontal axis between a bottom portion of the trough and a top portion of one of the peaks between which the trough is sandwiched.

12. The waveform-analyzing device according to claim 11, further comprising an integrator configured to integrate a peak identified as a multimodal peak by the multimodality determiner so as to allow the multimodal peak to be treated as a single peak.

13. The waveform-analyzing device according to claim 12, further comprising an operation section configured to receive a selecting operation by a user for selecting whether or not the integration by the integrator should actually be performed.

14. The waveform-analyzing device according to claim 11, wherein:
the overlap-peak region is subdivided into a plurality of kinds of regions according to the method for dividing the overlap peak, including a vertical partitioning peak region; and
the multimodality determiner is configured to make a determination on a peak corresponding to a vertical partitioning peak region as to whether or not the peak is a multimodal peak.

15. The waveform-analyzing device according to claim 11, wherein the multimodality determiner is configured so that one of conditions applied for determining that a peak concerned is a multimodal peak is that a height of a main peak or a shoulder peak is not greater than a predetermined threshold.

16. The waveform-analyzing device according to claim 11, wherein the multimodality determiner is configured to make a determination on the multimodal peak by using at least one of following values: a ratio between a height of a main peak and a height of a shoulder peak; a ratio between a depth of a trough between two peaks neighboring each other and a height of one of the two peaks; and a width of a portion between a bottom portion of the trough and a top portion of one of the two peaks.

17. The waveform-analyzing device according to claim 11, wherein the multimodality determiner is configured to calculate one or more of following values in the overlap-peak region: a signal-to-noise ratio, a degree of separation, a symmetry factor, an area and a peak width, and to use a calculated result for the determination on the multimodal peak as well.

18. The waveform-analyzing device according to claim 11, wherein the signal waveform is a chromatogram acquired by chromatograph mass spectrometry, and the multimodality determiner is configured to use both a determination result for a chromatogram of a target ion and a determination result for a chromatogram of a qualifier ion for a same component to make a determination on the multimodal peak.

19. The waveform-analyzing device according to claim 11, wherein the multimodality determiner is configured to use compound information related to a target compound for the determination on the multimodal peak.

20. The waveform-analyzing device according to claim 11, wherein the multimodality determiner is configured to use a change in waveform before and after a smoothing process on an overlap-peak waveform when making a determination on the multimodal peak.

21. An analyzing system which is a chromatograph system, a mass spectrometer or an optical measurement device, comprising the waveform-analyzing device according to claim 11 as a data analyzer.
